(19) United States
(12) Patent Application Publication
(10) Pub. No.: US 2018/0151018 A1
(43) Pub. Date: May 31, 2018

(54) DEVICE FOR DETERMINING THE FILLING LEVEL OF COIN TUBES

(71) Applicant: Crane Payment Innovations GMBH, Buxtehude (DE)

(72) Inventor: Thorsten Schneider, Apensen (DE)

(21) Appl. No.: 15/561,004

(22) PCT Filed: Feb. 29, 2016
(86) PCT No.: PCT/EP2016/054187

§ 371 Date: Jan. 17, 2018

(30) Foreign Application Priority Data
Mar. 24, 2015 (DE) 20 2015 101 489.9

(51) Int. Cl. G07D 9/00; G07D 5/02; G01S 17/10

(52) U.S. Cl. CPC G07D 9/004; G07D 2205/00; G01S 17/10; G07D 5/02

(57) ABSTRACT

The invention relates to a device for determining the filling level of at least one coin tube that can be filled with coins, comprising at least one optical radiation transmitter that is arranged in a defined position relative to the at least one coin tube in such a way that optical radiation transmitted by the optical radiation transmitter impinges on coins filled into the at least one coin tube and is reflected by coins filled into the at least one coin tube, also comprising at least one optical radiation receiver that is arranged in a defined position relative to the at least one coin tube in such a way that optical radiation, which is transmitted by the at least one optical radiation transmitter and reflected by coins filled into the at least one coin tube, is received by the at least one optical radiation receiver as a measurement signal, and comprising a control and evaluation apparatus which is connected to the at least one optical radiation transmitter and the at least one optical radiation receiver, and which is designed to control the at least one optical radiation transmitter for the transmission of optical radiation and to determine the filling level of the at least one coin tube having coins, based on a time period between the transmission of optical radiation and the receiving of the corresponding measurement signal by the at least one optical receiver.

### CROSS REFERENCE TO RELATED APPLICATIONS

The present application claims priority under 35 U.S.C. § 365 to International Patent Application No. PCT/EP2016/054187 filed Feb. 29, 2016 which claims priority to German Patent Application No. 20 2015 101 489.9 filed Mar. 24, 2015, which are incorporated herein by reference into the present disclosure as if fully set forth herein.

### TECHNICAL FIELD

The invention relates to a device for determining the filling level of at least one coin tube that can be filled with coins. In addition, the invention relates to a coin storage device for storing and/or counting out coins as well as a method for determining the filling level of at least one coin tube that can be filled with coins.

### BACKGROUND

For example, change machines usually have so-called coin tubes in which coins, which are stored in the change machine and which are to be paid out by the change machine, are stored stacked above one another. In this case, a coin tube is provided for each type of coin. It is necessary to establish the number of coins in the coin tubes, i.e. the filling level of the coin tubes, during operation. The process of achieving this by providing one or more light barriers, which are interrupted in the event of the coin stack exceeding one or more boundary heights in the coin tubes, is known. The disadvantage of this way of establishing the filling level is that only discrete filling level values can be established. If the height of the coin stack is located between two light barriers, the coins located between the light barriers are not detected. This means that this technology does not always provide sufficient accuracy in practice.

In addition, the use of sonic or ultrasonic sensors, which measure the time-of-flight of an ultrasonic signal from a transmitter to the topmost coin of a coin stack and back to a receiver, is known for the intended purpose. Based on this time-of-flight measurement, the distance between the ultrasonic transmitter or respectively receiver and the topmost coin is calculated, from which—if the coin thickness is known—the height of the coin stack and, therefore, the number of coins in the coin tube can in turn be deduced. The disadvantage of this technology is the strong dependence of the speed of sound and therefore the measurement result on the prevailing temperature and humidity. In addition, there is the fact that such ultrasonic sensors have a large blind region in which no reliable measurement is possible due to an overlapping of the transmitted and reflected sound signals. This blind region is located in the vicinity of the sound transmitter or respectively sound receiver. In practice, therefore, a considerable minimum distance between the sound transmitters or respectively sound receivers and the topmost coin of a coin stack, for example a distance of approx. 2 cm, is required for a reliable measurement. This, in turn, limits the capacity of the coin tubes for a given installation space of the device.

### SUMMARY

Starting from the explained prior art, the object of the invention is to provide a device, a coin storage device and a method of the type indicated above, with which an accurate and reliable determination of the filling level of coin tubes at the maximized filling capacity of the coin tubes is possible.

The invention achieves the object by the subject matter of the independent Claims 1, 7 and 9. Advantageous configurations are set out in the subordinate claims, the description and the figures.

The invention achieves the object, on the one hand, by a device for determining the filling level of at least one coin tube that can be filled with coins, comprising at least one optical radiation transmitter that is arranged in a defined position relative to the at least one coin tube in such a way that optical radiation transmitted by the optical radiation transmitter impinges on coins filled into the at least one coin tube and is reflected by coins filled into the at least one coin tube, also comprising at least one optical radiation receiver that is arranged in a defined position relative to the at least one coin tube in such a way that optical radiation, which is transmitted by the at least one optical radiation transmitter and reflected by coins filled into the at least one coin tube, is received by the at least one optical radiation receiver as a measurement signal, and comprising a control and evaluation apparatus which is connected to the at least one optical radiation transmitter and the at least one optical radiation receiver, and which is designed to control the at least one optical radiation transmitter for the transmission of optical radiation and to determine the filling level of the at least one coin tube having coins, based on a time period between the transmission of optical radiation and the receiving of the corresponding measurement signal by the at least one optical receiver.

On the other hand, the invention achieves the object by a method for determining the filling level of at least one coin tube that can be filled with coins, in which optical radiation is transmitted by an optical radiation transmitter that is arranged in a defined position relative to the at least one coin tube to coins filled into the at least one coin tube and is reflected by coins filled into the at least one coin tube, in which, in addition, the optical radiation, which is transmitted by the at least one optical radiation transmitter and reflected by coins filled into the at least one coin tube, is received by at least one optical radiation receiver that is arranged in a defined position relative to the at least one coin tube as a measurement signal, and in which the filling level of the at least one coin tube having coins is determined, based on a time period between the transmission of optical radiation by the at least one optical radiation transmitter and the receiving of the corresponding measurement signal by the at least one optical receiver.

According to the invention the determination of the filling level of the, for example, hollow cylindrical coin tubes is effected using at least one optical radiation transmitter and at least one optical radiation receiver. The at least one optical radiation transmitter and the at least one optical radiation receiver are in each case arranged in a defined position relative to the coin tube to be measured. The distances of the at least one optical radiation transmitter and of the at least one optical radiation receiver from the bottom of the at least one coin tube are therefore known. In the simplest embodiment, these distances are identical for the radiation transmitter and the radiation receiver. Therefore, the time period which optical radiation transmitted by the optical radiation transmitter would need on being reflected by the bottom of the empty coin tube for its journey back to the optical radiation receiver is also known.

In the case of a coin tube filled with coins, the time period established by the control and evaluation apparatus according to the invention for this route would be shorter because of the reflection by stacked coins located in the coin tube. At the same time, the thickness of the coins filled into the respective coin tube is known. Therefore, in the case of several coin tubes, only one type of coin is filled into each coin tube. The distance of the radiation transmitter or respectively radiation receiver from the topmost coin in the coin tube and, therefore, the filling level of the coin tube can be reliably deduced from the time period required by radiation transmitted by the at least one radiation transmitter to travel back to the radiation receiver.

Thanks to the time-of-flight measurement according to the invention, it is possible to measure the absolute distance from the optical sensors to the topmost coin of the respective coin tube. A time-of-flight measurement of light pulses is known per se. The at least one radiation transmitter transmits, for example, one short light pulse which impinges on the object to be measured, in this case the top side of the topmost coin in a coin tube. The light reflected by this coin arrives at the at least one radiation receiver which registers a corresponding measurement signal. The distance from the topmost coin and, therefore, the filling level of the coin tube can be determined from the time-of-flight measurement. The very high speed of light compared to, for example, sound waves is generally problematic when using light. As a result of the relatively low measurement distances in the application according to the invention, highly precise and quick sensors have to be used. However, such sensors are now available at reasonable costs.

The advantageous aspect of the time-of-flight measurement using optical radiation according to the invention is the independence from external influences such as the temperature, moisture, but also the reflectivity of the coins and ambient light. This means that the filling level of the respective coin tube can therefore be established precisely and reliably at any time independently of external influences. A relevant blind region as in the case of ultrasonic sensors does not exist either so that the filling capacity of the coin tubes can be maximized. At the same time, it is ensured according to the invention that each coin in the coin tube is taken account of in the measurement.

Inasmuch as mention is made of coins or coin tubes in the present application, this comprises both (metal) coins used in regular payment transactions and collectors' coins and, for example in the gaming field, tokens used in slot machines or in casinos, in particular metal or plastic tokens.

The at least one optical radiation transmitter, the at least one radiation receiver and the control and evaluation apparatus can be separate components, wherein the at least one optical radiation transmitter and the at least one radiation receiver are connected to the control and evaluation apparatus by suitable lines or similar. However, it is also possible that the at least one optical radiation transmitter, the at least one radiation receiver and the control and evaluation apparatus are fully or partially integrated into one joint component, in which the at least one optical radiation transmitter and the at least one radiation receiver are then also connected to the control and evaluation apparatus. The control and evaluation apparatus integrated into this joint component can then directly output the established distance from the topmost coin or the filling level, for example to an additional evaluation apparatus.

According to a particularly practical configuration, the at least one optical radiation transmitter can be at least one laser and the at least one optical radiation receiver can be at least one laser detector. For example, diode lasers can be used. They are characterized by a particular compactness and are at the same time cost-effective. The same applies to laser detectors which are suitable in this respect. Furthermore, a reliable distance measurement is also possible when using such radiation transmitters or respectively radiation receivers in the case of the small distances which are to be measured according to the invention. For example, the laser used can be a semiconductor laser designed as a surface emitter (VCSEL-Vertical Cavity Surface Emitting Laser).

According to another configuration, the control and evaluation apparatus can control the at least one optical radiation transmitter one or more times for the transmission of optical radiation pulses. After being reflected by the topmost coin of a coin tube, the radiation pulse is then received by the optical radiation receiver and the control and evaluation apparatus establishes the distance from the topmost coin from the time-of-flight measurement and, from this, the filling level of the coin tube. The optical radiation transmitter can, for example, transmit a radiation pulse for establishing the filling level at regular intervals and/or always following a filling operation of the respective coin tube. If multiple coin tubes are provided, as explained in greater detail below, only the radiation transmitter allocated to the respective coin tube can be controlled for the transmission of a radiation pulse for example, during a filling operation of one of the coin tubes. However, it is also possible to generally control all of the radiation transmitters for the transmission of a radiation pulse during a filling operation of one of the coin tubes.

According to another configuration, it can be provided that the at least one optical radiation transmitter is arranged relative to the at least one coin tube in such a way that the optical radiation transmitted by the at least one optical radiation transmitter impinges on coins filled into the coin tube substantially in the axial direction of the at least one coin tube, and that the at least one optical radiation receiver is arranged relative to the at least one coin tube in such a way that the optical radiation reflected by the coins filled into the coin tube impinges on the optical radiation receiver substantially in the axial direction of the at least one coin tube. The optical light/beam paths from the radiation transmitter to the coins and from the coins back to the radiation receiver are then substantially parallel to one another and extend substantially in the axial direction of the respective coin tube. In particular, radiation transmitted by the radiation transmitter impinges from above on the top side of the topmost coin of a respective coin tube. This results in a particularly simple evaluation of the time-of-flight measurement. In particular, the optical radiation receiver and the optical radiation transmitter can (in each case) be arranged such that they are at the same distance from the bottom of the respective coin tube or respectively from the surface of coins stacked into the respective coin tube.

According to another configuration, it can be provided that the device comprises a plurality of optical radiation transmitters and a plurality of optical radiation receivers, wherein a radiation transmitter and radiation receiver pair respectively is in each case allocated to one of multiple coin tubes, wherein the optical radiation transmitters are each arranged in a defined position relative to the respective coin tube in such a way that optical radiation transmitted in each case by the optical radiation transmitters impinges on coins filled into the respective coin tube and is reflected by coins filled into the respective coin tube, and wherein the optical radiation receivers are each arranged in a defined position relative to the respective coin tube in such a way that optical radiation, which is transmitted by the respective optical radiation transmitter and reflected by coins filled into the respective coin tube, is received by the respective optical radiation receiver as a measurement signal, and wherein the control and evaluation apparatus is connected to each radiation transmitter and each radiation receiver, and is designed to control the optical radiation transmitters in each case for the transmission of optical radiation and to determine the filling level of the respective coin tube having coins, based on a time period between the transmission of optical radiation by the respective optical radiation transmitter and the receiving of the corresponding measurement signal by the respective optical receiver.

This configuration has already been dealt with above. In this case, a pair made up of one radiation transmitter and one radiation receiver is in each case allocated to one coin tube. For each coin tube, the time-of-flight measurement according to the invention is then carried out with the respective radiation transmitter and radiation receiver pair and, from this, the respective distance of the sensors from the topmost coin in the coin tube and, therefore, the filling level of the respective coin tube is deduced. The radiation transmitters and radiation receivers can in particular be configured or respectively arranged in the way explained above in this configuration.

It is in this respect also conceivable to provide a joint optical radiation transmitter and/or a joint optical radiation receiver for one or all of the coin tubes, wherein the joint optical radiation transmitter or respectively the joint optical radiation receiver is optically connected to the coin tubes by means of a fiber optic cable. In this way, the establishment of the filling level explained above can be carried out for multiple coin tubes using, for example, only one optical radiation transmitter and/or only one optical radiation receiver. This simplifies the design configuration.

Especially when using a joint optical radiation transmitter for all of the coin tubes at the same time as providing, in each case, an optical radiation receiver above each coin tube, the received signals can be controlled and evaluated respectively as explained above. When using a joint optical radiation receiver at the same time as providing, in each case, an optical radiation transmitter above each coin tube, the control and evaluation respectively have to be adapted in order to clearly allocate the signals received by the joint radiation receiver. It is then conceivable, for example, that the radiation transmitters allocated to the coin tubes are controlled with a temporal offset so that the coin tube examined in each case can be deduced, based on the time of the measurement signal received by the radiation receiver. It would also be conceivable for the fiber optic cables, which route the signal reflected by the coins to the radiation receiver, to route this measurement signal in each case to different regions of the measuring surface of the radiation receiver. A clear allocation of the measurement signals to the examined coin tubes can then be carried out based on the local distribution of the measurement signals.

The invention also achieves the object by means of a coin storage device for storing and/or counting out coins, comprising one or more coin tubes that can be filled or respectively is/are filled with coins and comprising a device according to the invention for determining the filling level of the one or more coin tubes. The coin storage device can, in particular, be a change machine which is used, for example, in payment machines. It has a coin inlet, through which coins are supplied to a coin checking apparatus of the change machine. The genuineness and the type of the supplied coins are, in each case, determined in the coin checking apparatus. Depending on the result of the check, the coins are then filled into the coin tubes provided for the respective coin type or, if the coins are not genuine, supplied to an outlet. In this case, the coin tubes are usually located below the coin checking apparatus. The optical radiation transmitter and optical radiation receiver according to the invention as well as the control and evaluation apparatus can then be integrated into the coin checking apparatus.

According to another configuration regarding this, it can be provided that the control and evaluation apparatus counts out coins from the coin tubes, if a plurality of coin tubes and pairs of radiation transmitters and radiation receivers are present, based on filling levels determined for the individual coin tubes in such a way that the filling levels in the coin tubes do not fall below a predefined minimum value in each case. Intelligent coin management therefore takes place on the basis of the measurement results of the sensors according to the invention. By outputting certain coins, the coin changer can influence the filling levels of the individual coin tubes within certain limits so that sufficient coins of each type of coin are available at all times. If, nevertheless, the number of coins in one of the coin tubes falls below the predefined minimum value, the coin changer can output a warning signal.

The method according to the invention can in particular be carried out with the device according to the invention. Accordingly, the device according to the invention can in particular be suitable and designed for carrying out the method according to the invention.

### BRIEF DESCRIPTION OF THE DRAWINGS

Embodiment examples of the invention will be explained below with reference to figures, wherein:

FIG. 1 schematically shows a representation of a device according to the invention in order to explain the measuring principle according to the invention in a sectional view, and

FIG. 2 schematically shows a coin storage device according to the invention for storing and/or counting out coins in a dismantled condition for illustrative purposes in a partially transparent perspective representation.

### DETAILED DESCRIPTION

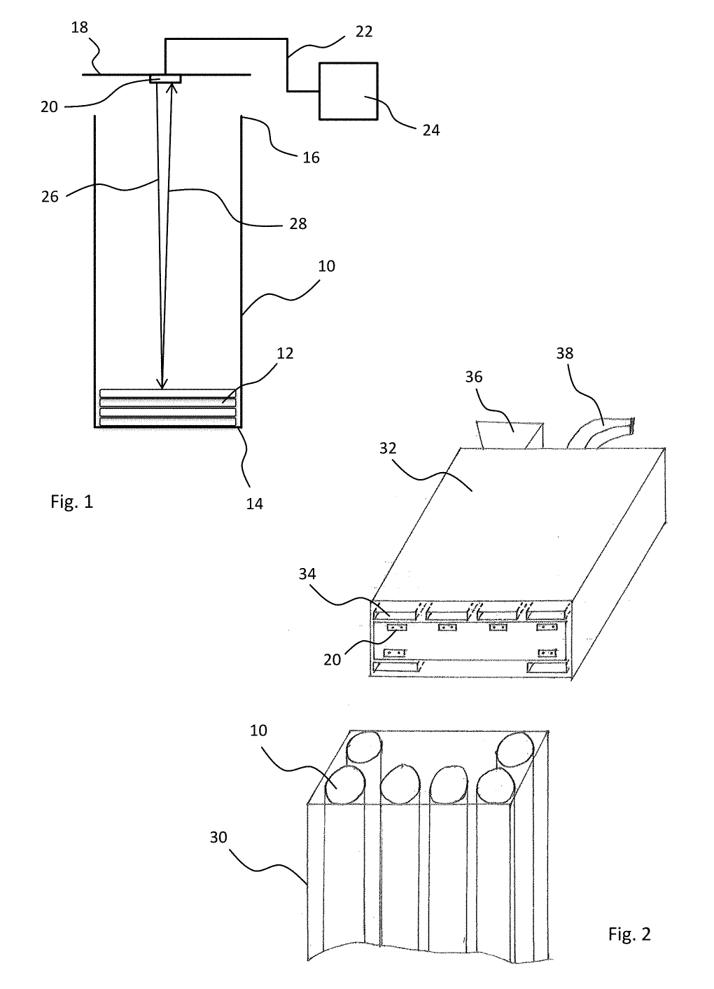

Unless otherwise indicated, the same reference numerals designate the same objects in the figures. In FIG. 1 a coin tube is shown with reference numeral 10, which can be used for example in a coin storage device for storing and/or counting out coins, as shown in FIG. 2. Multiple coins 12, four in the example shown, are located stacked in the coin tube 10, in particular on the bottom 14 of the coin tube 10. Located above the open end 16 at the top of the coin tube 10 are optical sensors 20 which are retained by a retaining plate 18. The optical sensors 20 have an optical radiation transmitter, in this case a laser, in particular a semiconductor laser such as a VCSEL, and an optical radiation receiver, in this case a suitable laser detector. The optical radiation transmitter and the optical radiation receiver are connected to a control and evaluation apparatus 24 of the device by means of a line 22.

During operation, the control and evaluation apparatus 24 controls the optical radiation transmitter one or more times for the transmission of an optical radiation pulse. The optical radiation transmitted by the optical radiation transmitter impinges on the top side of the topmost coin 12 filled into the coin tube 10 substantially in the axial direction of the coin tube 10, as illustrated by the arrow 26 in FIG. 1. The top side of the topmost coin 12 reflects the optical radiation so that this, in turn, travels back substantially in the axial direction of the coin tube 10 to the optical radiation receiver, as shown by the arrow 28 in FIG. 1. The measurement signal received by the radiation receiver is routed via the line 22 to the control and evaluation apparatus 24. Based on the time-of-flight of the optical radiation transmitted by the optical radiation transmitter to the top side of the topmost coin 12 and back to the optical radiation receiver, the control and evaluation apparatus 24 establishes the distance of the sensors 20 from the top side of the topmost coin 12 in the coin tube 10. Due to the defined position of the sensors 20 with respect to the coin tube 10 and the known distance from the underside 14 of the coin tube 10, the filling level of the coin tube 10 having coins can be deduced from the distance established by measurement technology if the thickness of the coins 12 filled into the coin tube 10 is known. This is effected in the present case by the control and evaluation apparatus 24.

FIG. 2 shows a coin storage device according to the invention for storing and counting out coins, in particular a change machine, as used for example in payment machines. The coin storage device shown in FIG. 2 substantially consists of two housing parts which are shown dismantled in FIG. 2 for illustrative purposes. Six coin tubes 10 are arranged upright in a distributed manner in a lower housing part 30 in the example shown. The coin tubes 10 are in each case, for example, configured as shown in FIG. 1 and are filled with different types of coins, wherein only one type of coin is in each case filled into each of the coin tubes 10 in FIG. 2, as shown in FIG. 1 with reference to a coin tube 10.

A coin checking apparatus is located in a housing upper part 32 of the coin storage device. During operation, the housing upper part 32 is mounted with the underside which is visible on the front side in FIG. 2 onto the top side of the housing lower part 30. A plurality of coin slots, in the present case six coin slots 34, are located on the underside of the housing upper part 32. In the case of the housing upper part 32 mounted on the housing lower part 30 one coin slot 34 is in each case aligned with one of the coin tubes 10. On its top side, the housing upper part 32 has a coin inlet 36 through which coins are supplied to the coin storage device and, in particular, firstly to the coin checking apparatus arranged in the housing upper part 32. The coin checking apparatus examines the supplied coins for genuineness and coin type and routes these—if they are genuine—depending on their type via the coin slots 34 in each case to one of the coin tubes 10. The coin slots 34 therefore form sorting outlets of the coin checking apparatus.

On the top side of the housing upper part 32 there is, furthermore, a return lever 38 which can, for example, be operated manually, via which, for example in the event of a coin blockage of the coin checking apparatus, supplied coins can be output. In each case adjacent to one of the coin slots 34 there are located respectively sensors 20, as shown in FIG. 1 and explained by way of example with reference to FIG. 1. In particular, each of the sensors 20 in FIG. 2 comprises an optical radiation receiver and an optical radiation transmitter, in particular a laser and a laser detector, as explained by way of example above. If the housing upper part 32 is mounted in accordance with the provisions on the housing lower part 30, the sensors 20 or respectively the radiation transmitters and radiation receivers are in each case aligned to one of the coin tubes 10, as shown in FIG. 1. In particular, the optical beam paths 26, 28 shown in FIG. 1 based on sensors 20 and a coin tube 10 are in each case produced for each of the sensors 20 and coin tubes 10. Each of the sensors 20 or respectively each of the radiation transmitters and radiation receivers of the coin storage device in FIG. 2 is, in this case, connected to the control and evaluation apparatus 24 which is arranged in the exemplary embodiment shown in FIG. 2 inside the housing upper part 32.

During operation, the control and evaluation apparatus 24 controls the radiation transmitter of the sensors 20 in each case for the transmission of one or more radiation pulses. The measurement signals received accordingly by the respective radiation receivers are in turn forwarded to the control and evaluation apparatus 24, wherein the control and evaluation apparatus 24 uses these, in each case, to establish the distance of the sensors 20 or respectively the radiation transmitters and radiation receivers respectively from the topmost coin filled into the respective coin tube 10 and uses these, in each case, to determine the filling level of the coin tubes 10.

It is, in this case, possible for example that the control and evaluation apparatus 24 controls all of the radiation transmitters respectively following a filling operation of at least one of the coin tubes 10 for the transmission of a radiation pulse. It is, however, also conceivable that the control and evaluation apparatus 24 only controls the radiation transmitter allocated to the filled coin tube 10 respectively for the transmission of a radiation pulse.

1. A device for determining a filling level of at least one coin tube that can be filled with coins, comprising:
at least one optical radiation transmitter that is arranged in a defined position relative to the at least one coin tube in such a way that optical radiation transmitted by the at least one optical radiation transmitter impinges on coins filled into the at least one coin tube and is reflected by coins filled into the at least one coin tube,
at least one optical radiation receiver that is arranged in a defined position relative to the at least one coin tube in such a way that optical radiation, which is transmitted by the at least one optical radiation transmitter and reflected by coins filled into the at least one coin tube, is received by the at least one optical radiation receiver as a measurement signal, and
a control and evaluation apparatus which is connected to the at least one optical radiation transmitter and the at least one optical radiation receiver, and is configured to control the at least one optical radiation transmitter for the transmission of optical radiation and to determine the filling level of the at least one coin tube having coins, based on a time period between the transmission of optical radiation and the reception of a corresponding measurement signal by the at least one optical receiver.

2. The device according to claim 1, wherein the at least one optical radiation transmitter is at least one laser and the at least one optical radiation receiver is at least one laser detector.

3. The device according to claim 1, wherein the control and evaluation apparatus is configured to control the at least one optical radiation transmitter one or more times for the transmission of optical radiation pulses.

4. The device according to claim 1, wherein the at least one optical radiation transmitter is arranged relative to the at least one coin tube in such a way that the optical radiation transmitted by the at least one optical radiation transmitter impinges on coins filled into the coin tube substantially in an axial direction of the at least one coin tube, and that the at least one optical radiation receiver is arranged relative to the at least one coin tube in such a way that the optical radiation reflected by the coins filled into the coin tube impinges on the at least one optical radiation receiver substantially in the axial direction of the at least one coin tube.

5. The device according to claim 1, further comprising:
a plurality of optical radiation transmitters and a plurality of optical radiation receivers,
wherein a radiation transmitter and radiation receiver pair are each respectively allocated to one of multiple coin tubes,
wherein the optical radiation transmitters are each arranged in a defined position relative to the respective coin tube in such a way that optical radiation transmitted by the optical radiation transmitters impinges on coins filled into the respective coin tube and is reflected by coins filled into the respective coin tube,
wherein the optical radiation receivers are each arranged in a defined position relative to the respective coin tube in such a way that optical radiation, which is transmitted by the respective optical radiation transmitter and reflected by coins filled into the respective coin tube, is received by the respective optical radiation receiver as a measurement signal, and
wherein the control and evaluation apparatus is connected to each radiation transmitter and each radiation receiver, and is configured to control the optical radiation transmitters in each case for the transmission of optical radiation and to determine the filling level of the respective coin tube having coins, based on a time period between the transmission of optical radiation by the respective optical radiation transmitter and the receiving of the corresponding measurement signal by the respective optical receiver.

6. The device according to claim 1, wherein the control and evaluation apparatus is configured to determine the filling level of a plurality of coin tubes that can be filled with coins, wherein at least one of a joint optical radiation transmitter or a joint optical radiation receiver is provided for one or all of the coin tubes, and wherein at least one of the joint optical radiation transmitter or the joint optical radiation receiver is optically connected to the coin tubes via a fiber optic cable.

7. A coin storage device for storing or counting out coins, comprising:
one or more coin tubes that can be filled with coins;
at least one optical radiation transmitter that is arranged in a defined position relative to at least one coin tube, of the one or more coin tubes, in such a way that optical radiation transmitted by the optical radiation transmitter impinges on the coins filled into the at least one coin tube and is reflected by coins filled into the at least one coin tube,
at least one optical radiation receiver that is arranged in a defined position relative to the at least one coin tube in such a way that optical radiation, which is transmitted by the at least one optical radiation transmitter and reflected by coins filled into the at least one coin tube, is received by the at least one optical radiation receiver as a measurement signal, and
a control and evaluation apparatus which is connected to the at least one optical radiation transmitter and the at least one optical radiation receiver, and which is designed to control the at least one optical radiation transmitter for the transmission of optical radiation and to determine a filling level of the at least one coin tube having coins, based on a time period between the transmission of optical radiation and the receiving of the corresponding measurement signal by the at least one optical receiver.

8. The coin storage device according to claim 7, wherein the control and evaluation apparatus is configured to count out coins from the coin tubes, based on filling levels determined with the device for each of the coin tubes in such a way that the filling levels in the coin tubes do not fall below a predefined minimum value in each case.

9. A method for determining a filling level of at least one coin tube that can be filled with coins, the method comprising:
transmitting, by at least one optical radiation transmitter, optical radiation that is arranged in a defined position relative to the at least one coin tube to coins filled into the at least one coin tube and is reflected by coins filled into the at least one coin tube,
receiving the optical radiation, which is transmitted by the at least one optical radiation transmitter and reflected by coins filled into the at least one coin tube, by at least one optical radiation receiver that is arranged in a defined position relative to the at least one coin tube as a measurement signal, and
determining the filling level of the at least one coin tube having coins, based on a time period between the transmission of optical radiation by the at least one optical radiation transmitter and the receiving of a corresponding measurement signal by the at least one optical receiver.

10. The method according to claim 9, wherein the at least one optical radiation transmitter transmits an optical radiation pulse one or more times.

11. The method according to claim 9, wherein the optical radiation transmitted by the at least one optical radiation transmitter impinges on coins filled into the coin tube substantially in an axial direction of the at least one coin tube, and that the optical radiation which is reflected by the coins filled into the coin tube impinges on the optical radiation receiver substantially in the axial direction of the at least one coin tube.

12. The method according to claim 9, wherein a plurality of optical radiation transmitters and a plurality of optical radiation receivers are provided, wherein a radiation transmitter and radiation receiver pair are each respectively allocated to one of multiple coin tubes, wherein the optical radiation transmitters are each arranged in a defined position relative to the respective coin tube, and wherein the optical radiation receivers are in each case arranged in a defined position relative to the respective coin tube, wherein optical radiation is in each case transmitted by the optical radiation transmitters, impinges on the coins filled into the respective coin tube and is reflected by coins filled into the respective coin tube, and wherein optical radiation, which is transmitted by the respective optical radiation transmitter and reflected by coins filled into the respective coin tube, is received by the respective optical radiation receiver as a measurement signal, and wherein the filling level of the respective coin tube having coins is determined, based on a time period between the transmission of optical radiation by the respective optical radiation transmitter and the receiving of the corresponding measurement signal by the respective optical receiver.

13. The method according to claim 9, wherein the filling level of a plurality of coin tubes that can be filled with coins is determined, wherein a joint optical radiation transmitter and/or a joint optical radiation receiver is/are used for one or all of the coin tubes, wherein the joint optical radiation transmitter and/or the joint optical radiation receiver is/are optically connected to the coin tubes by means of a fiber optic cable.

14. The method according to claim 13, wherein based on filling levels determined in each case for the coin tubes coins are counted out from the coin tubes in such a way that the filling levels in the coin tubes do not fall below a predefined minimum value in each case.

15. (canceled)
